(19) United States
(12) Patent Application Publication
(10) Pub. No.: US 2008/0195555 A1
(43) Pub. Date: Aug. 14, 2008

(54) METHOD AND INSTRUMENT FOR GENERATING AND TRADING IDENTIFIABLE PLURAL OWNERSHIP RIGHTS IN ASSETS

(76) Inventor: Peter Carr, Burwood (AU)

Correspondence Address: Peter Carr, PO Box 244, Burwood, Sydney, New South Wales, 1805, omitted

(21) Appl. No.: 11/873,336

(22) Filed: Oct. 16, 2007

Related U.S. Application Data
(60) Provisional application No. 60/862,763, filed on Oct. 24, 2006.

(51) Int. Cl. G06Q 40/00; G06Q 90/00

(52) U.S. Cl. 705/36 R; 705/500; 705/37

(57) ABSTRACT

A method and instrument for raising finance from generating and trading identifiable plural ownership rights in assets, such as intellectual property, or other properties and any associated rights or benefits, such as profit streams. An exemplary method comprising generating a plurality of identifiable ownership rights and facilitating the buying and selling of said identifiable rights to members of the public and others. An exemplary instrument comprises a plurality of identifiable ownership rights enabling plural ownership of an asset or property and any associated rights or benefits by members of the public and other entities. The asset or property may be defined to be intellectual property or some other property, benefit or other associated right owned by a seller, member of the public or other entity and capable of generating a profit stream or some other benefit. This methods advantages include raising finance for sellers, and enabling the public to participate.

### CROSS REFERENCED RELATED APPLICATIONS

This application claims benefit of provisional application No. 60/862,763, filed Oct. 24, 2006 and titled “A METHOD AND INSTRUMENT FOR GENERATING AND TRADING IDENTIFIABLE PLURAL OWNERSHIP RIGHTS IN ASSETS”.

### FEDERALLY SPONSORED RESEARCH

None.

### SEQUENCE LISTING OR PROGRAM

None.

### BACKGROUND OF THE INVENTION

1. Field of Invention

This invention is directed to a method and instrument for enabling individuals, businesses and other entities to raise finance by selling parts or percentages (“Portions”) in the ownership rights of Intellectual Property or some other asset capable of generating profits.

This invention, conceived in 2001 and kept confidential since this time, is the result of many years of research and experience working on business development with small and medium sized enterprises in the creative and entertainment sector. The inventor concluded that many, if not indeed most, creative-sector and other IP focussed businesses fail because they cannot obtain the business finance that they require for their business needs.

This is due to 2 main factors; Firstly, institutional financiers such as banks almost universally regard creative sector business endeavours as extremely high risk, and will not provide business finance unless the entrepreneur seeking such finance is willing to provide ‘guarantees’ such as their personal home. The majority of entrepreneurs are unable or unwilling to satisfy these requirements. Angel investors and venture capitalists have a similar attitude toward entertainment sector businesses. The various stock markets provide another mechanism for business to raise finance, but generally the professional and other fees and associates costs for a business to raise finance on a stock market are out of reach of the vast majority of small to medium sized enterprises particularly in those in the creative sectors.

Secondly, because institutional and angel investors are generally unwilling to invest, on the whole investment can only be secured from a small number of key players within the entertainment sector, such as Major Record Companies and Major Film Studios and other major financial players. These few companies have neither the means to finance all of the enormous number of creative sector businesses requiring financing, nor do they provide financing in a transparent and market driven manner, Rather, they make their own decisions behind closed doors, based upon their own criteria.

The result of these two factors is that (i) only a very small fraction of creative sector businesses ever obtain the funding they require, resulting in the majority failing in their business endeavours and (ii) the small proportion of businesses that do raise finance are not necessarily the businesses that the market would consider to be the best investment risk.

Therefore, given the significant contribution that entertainment and creative sector businesses make to modern economies such as the USA, UK etc, the lack of financing available for creative sector businesses is not only damaging the thousands upon thousands of businesses that fail as a result of their inability to secure financing, but the overall national economies of these countries.

This invention will solve this major economic problem, by creating a revolutionary new method for providing business financing for creative sector businesses. It will thereby lead to a dramatic increase in the number of successful and sustainable businesses within the creative sector, and subsequent increase in the GDP of the national economies where this invention is available.

This invention does this by providing a method and system for entrepreneurs to raise finance by selling to a very large number of individuals in the general public, small portions of the units, ownership or other rights in the intellectual property that they produce or own or control.

Thus, this invention creates a ‘market driven’ and transparent method for entrepreneurs to raise finance, which will be based upon merit and the opinion of thousands of small investors as to which investment is a good risk, and the general principles of supply and demand.

Those investing become part owners of that intellectual property, and stakeholders with a say in the day-to-day running of the intellectual property and associated enterprise they have invested in. For example, fans can invest directly in their favourite band's next album production, in return for a pro-rata ownership of the resulting intellectual property (the master recording), and any benefits (such as profits) that may be attached.

This invention can be equally applied to other intellectual-property or asset-based projects that require finance, and that may be capable of generating further benefits such as a profit stream. For instance biotechnology projects, software development, engineering projects or property construction projects could also benefit from this invention. These examples are by way of illustration only, and not intended to be limited in any way.

2. Prior Art

To date, attempts at providing financing for the entertainment industry using intellectual property as the basis of some form of security for investment have proven to be complex to operate and inaccessible to the vast majority of small enterprises and individuals. U.S. Pat. No. 7,062,457 to Kaufman (2006) shows “A system for purchasing from an intermediary a right to a payment related to the performance of an entertainment production”. Kaufman's invention's claims include substantial number of highly restrictive, specific elements, (at least 12 elements per claim) with Kaufman's various descriptions and all of his claims involving an intermediary company (the “Financing Entity”) that sits between the entities seeking to raise the finance (the “Entertainment Company's”) and those making the investments. This intermediary he calls the “intermediary financing entity”. And whilst at the core of our invention is a direct relationship and stated benefits of this direct relationship, between the entities seeking to raise finance and the those investing, Kaufman's use of this intermediary financing entity places an extreme burden of risk on this intermediary financing entity, which will have no defined control over the project or any revenues from the project, yet will be answerable and accountable to all of the investors. This scenario would be hugely undesirable and unrealistic for most businesses. Additionally, in Kaufman's system and method, as the investors are investing in the intermediary financing entity or in a form of unit trust created by the intermediary, they will have no direct ownership of the projects being funded and will therefore be completely reliant on the intermediary for any returns, with the Entertainment Company not being accountable to the investors. The method and system would create a situation that if the project being funded failed, the intermediary, and the investors would suffer the loss, and the Financing Entity would be accountable to the investors, the Entertainment Company would not be accountable to the investors. Furthermore, the potential returns to the investors are vaguely defined, and described as being merely “related to the performance of an entertainment production”, rather than determined by the performance.

US Pat. No. 20050038730 to Scot (2005) describes “A method and instrument for allowing for public investment in an intellectual property (IP) business, such as a patent business, of a publicly held corporation”. Unlike our invention, this invention again requires an intermediary device (the “intellectual property business”) that sits between the entity seeking the finance, and the investors. And as a further intermediary device, the intermediary releases to the investors and the public a “tracking stock”. Scots method is an overly complex method that he has specifically defined in his description and all his claims as being only for Public Corporations, unlike our invention which is available to any business type, and even individuals, to raise finance. Furthermore, Scots method does not provide any investors with rights of control or ownership of the IP that their “tracking stock” is tracking, and hence is a very high risk investment for them that does not provide any assets to them.

WIPO Pat. No. WO01577748/JP2001216456 to Masaharu, Masahiro, Sato and Chiyoko (2001) like most related inventions provides a business to business solution, and is not geared to giving members of the public a stake in the development of new entertainment or IP based projects or products. This particular invention provides an on-line business to business brokerage system and again requires an intermediary. It also does not provide for the transfer of part of IP based rights to multiple buyers, hence limiting the number of investors for any seller looking to raise finance. There is no opportunity for buyers to ascertain past performance of the seller's IP, nor to sample elements of the IP (such as video footage). This invention demands that the seller sell via auction to the highest bidder for the IP on sale. This may mean that a seller of IP is forced to sell to a bidder even-though the bidding price does not provide their required level of financing. It is therefore unsuitable as a means of raising a pre-determined amount of required finance.

US Pat. US2005256777 is; “An intellectual property right selling/buying system and method enables transfer of an intellectual property right selling/buying right to a broker by employing the call option method and acquiring a call option fee”. This is a highly specific method and system, only specifically for selling and transferring intellectual property rights to brokers, and is again a business to business solution designed for a seller to sell an intellectual property right to one seller, rather than to divide a intellectual property right into units and sell these to a number of buyers, as is the case with our invention. Furthermore, the inventors Yasuo and Takao have specified that “the price is determined at the Web Site” and presented to the applicant, rather than being specified by the seller/applicant.

The Hollywood Stock Exchange (www.hsx.com) is an interesting example of a device that combines elements, mentioned in previous inventions such as mirror stock, but for a solution that is merely a game. This gaming website acts as a virtual ‘stock exchange’ that encourages members of the public to trade in virtual stock based on the success of celebrities and major film productions. It utilises the mainstream entertainment industry and as a gaming device does not create any ownership of any asset, nor foes it create a financing mechanism for any individual or business.

### OBJECTS AND ADVANTAGES

Accordingly, several objects and advantages of our invention are to provide a means of raising finance for individuals and other entities. Traditionally the process for raising finance for entertainment projects has been exclusively aimed at companies or corporate entities (not individuals) via publicly held companies, finance institutions or investment trusts. Our invention is particularly suited to small and medium sized enterprises and individuals enabling them to raise finance from selling parts of or percentages in their intellectual property and/or associated rights and benefits, whether this be existing intellectual property or intellectual property that is to be created at future date (for instance raising film finance for a film that will be put into production at a specified date in the future).

Our invention enables those providing the finance (for example members of the public) and those requiring the finance (for example creators of IP) can partake directly in transactions. Thus there is no requirement for a financial intermediary. This overcomes the often-onerous application requirements set by institutional and corporate finance providers currently faced by individuals and other entities when applying for finance for their IP based projects.

Our invention enables a company or individual to sell or transfer parts or percentages of the actual ownership of their intellectual property and/or associated rights and/or benefits rather than issuing stock that track and represents the performance of IP held by a company. There is no intermediary finance entity to create any form of mirror stock or form of securities or the creation of unit trusts of IP sold by sellers, there is no requirement for buyers to buy into any such mirror stock or form of securities or unit trusts.

Our invention is based on real-time currency transactions and enables multiple buyers to acquire interests in one single item of IP. Those multiple buyers are in turn able to trade those enforceable interests with others. Our invention is not a gaming instrument nor an investment trust and does not relate to virtual stock or currency.

Sellers are free to sell and buyers are free to buy without any onerous requirements for lengthy transaction negotiations. There is no requirement for complicated encrypted contracts between buyers and sellers. Our method and instrument does not require nor involve any negotiation between buyers and sellers involving third parties so it is not a brokerage.

Our invention moves away from the traditional finance model for the entertainment industry of commercial financing that relies on intermediaries, finance institutions and brokers. The traditional model stifles new and innovative IP based projects and businesses who cannot access such traditional form of financing. Instead our invention enables direct investment by members of the public in support of the IP based projects that interest them, in return for a stake in the IP they have invested in.

In conclusion, insofar as I am aware, no former means of raising finance involving assets such as intellectual property rights has proved realistic or workable. No former means of raising finance has used the same device of dividing an asset such as a piece of intellectual property into small parts which are then sold individually to a large number of buyers. Previous inventions have generally involved all, or some of the following prohibitive elements: a financial intermediary, a very high burden of financial risk for investors, an absence of any share or ownership in underlying assets for investors. No previous invention has addressed the finance needs of small to medium sized enterprises and individuals by enabling them to realise capital directly from their IP or other property or assets owned. It seems that to date, all of the existing inventions aimed at using IP or assets as a vehicle for financing are completely inaccessible to the majority of individuals or small enterprises.

### SUMMARY

In accordance with the invention, this is a new and improved method and instrument for raising finance from generating and trading identifiable plural ownership rights in assets, such as intellectual property rights and any associated benefits (e.g. profit streams).

Accordingly several objects and advantages of the invention are to provide a means for individuals, small enterprises and others to generate finance, even a specific amount of finance, from a portion or percentage of their property or asset. This finance can be generated without having to relinquish full control over the asset.

A benefit of our invention is that it provides a means for members of the public (and others) to support individual projects, individuals or companies directly yet does not require an intermediary finance institution. The financial risk for investors is limited in that it provides a refund safety mechanism and investors have a say in the day-to-day management of their investment.

It provides a mechanism for generating real enforceable ownership rights for multiple owners from any asset. Those rights can be freely bought, sold and transferred, and those rights be tracked and monitored for the duration of their existence. Still further objects and advantages of our invention will become apparent from a study of the following description and accompanying drawings.

### DRAWINGS—FIGURES

FIG. 1 is The Description of the Preferred Embodiment

FIG. 1 A. is The Seller/User Operation Preferred Embodiment and shows a flowchart of the operation of the Selling mechanism of the Preferred Embodiment

FIG. 1 B. is The Buyer/User Operation Preferred Embodiment and shows a flowchart of the operation of the Buying mechanism of the Preferred Embodiment

FIG. 1 C. is The Performance Tracking Operation Preferred Embodiment and shows a flowchart of the operation of the Tracking mechanism of the Preferred Embodiment

FIG. 2 is The Description of Alternative Embodiment A

FIG. 2 A. is The Seller/User Operation Alternative Embodiment A and shows a flowchart of the operation of the Selling mechanism of the Alternative Embodiment A

FIG. 2 B. is The Buyer/User Operation Alternative Embodiment A and shows a flowchart of the operation of the Buying mechanism of the Alternative Embodiment A

FIG. 2 C. is The Performance Tracking Operation Alternative Embodiment A and shows a flowchart of the operation of the Tracking mechanism of the Alternative Embodiment A

FIG. 3 is The Alternative (Off Line) Alternative Embodiment B

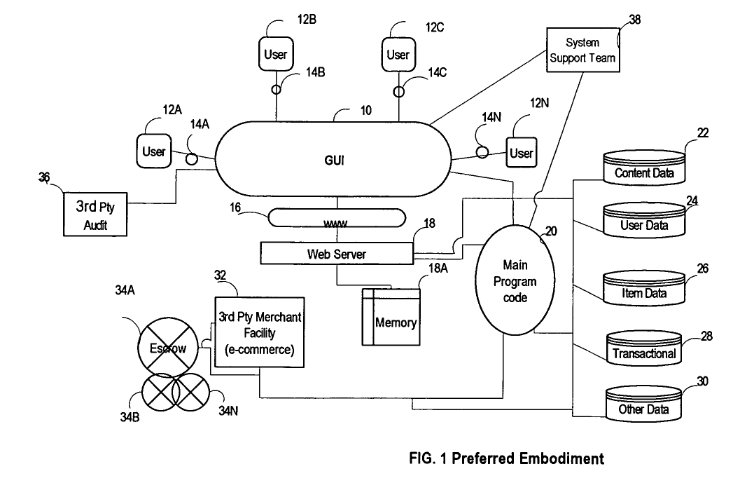

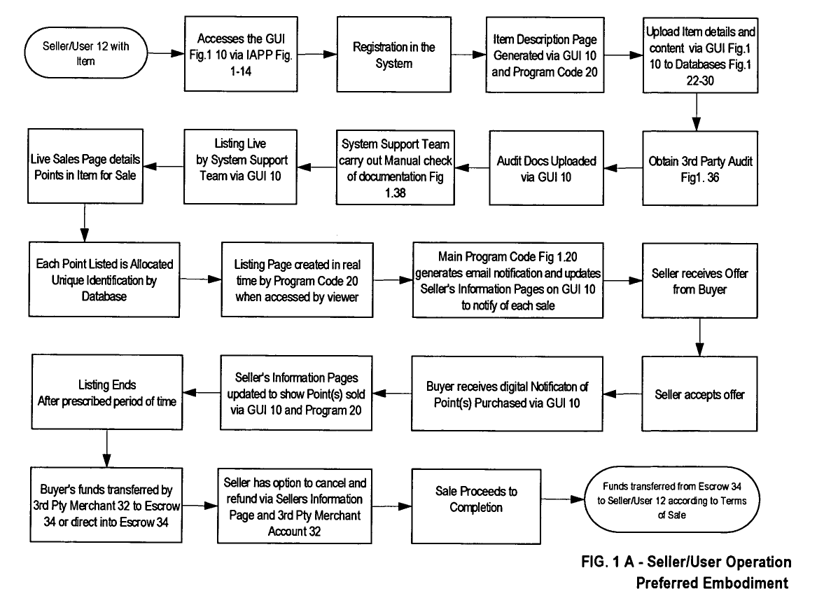

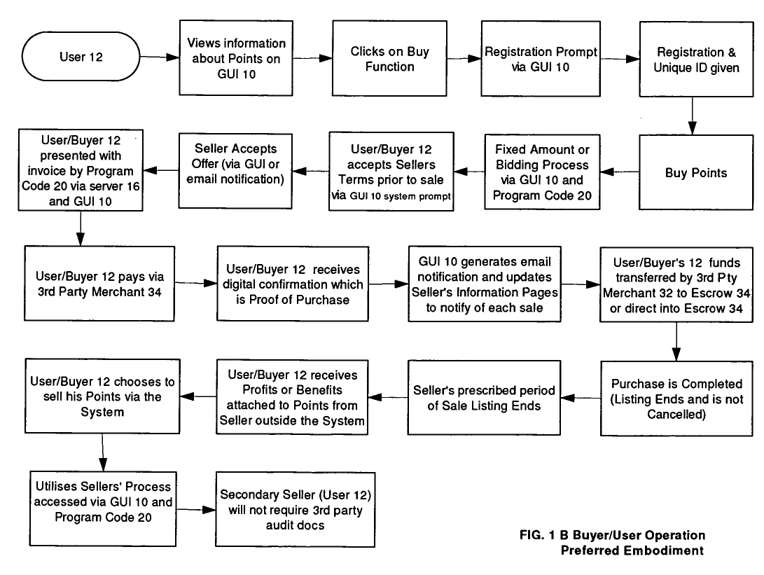

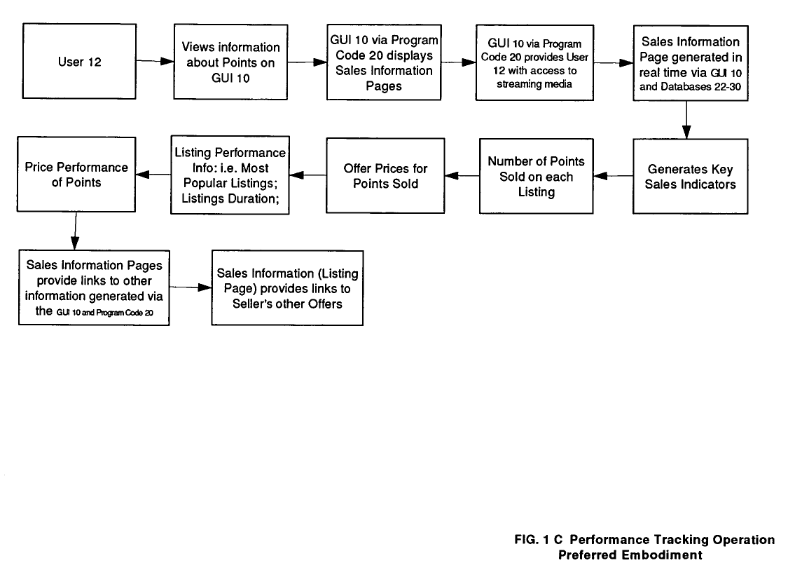

### DRAWINGS—REFERENCE NUMERALS FIG. 1

10 Graphic User Interface (GUI)
12A-N Multiple Users—connected via the GUI over the internet by means of 14 A-N
14 A-N Individual Information Appliance—users connect to the GUI by means of an appliance such as a general purpose computer with a display and memory or PDA capable of connecting to the internet and supporting a browser for surfing the internet
16 WWW—world wide web 16 forming the connection between the web server 18 and the GUI 10
18, 18A Web Server—hosting the main program and containing sufficient memory 18A for hosting the main program and capable of interrogating the databases 22-30
20 Main Program code—(such as PHP or Pearl or other suitable language) capable of communicating with, interrogating and receiving information from databases 22-30.
22 Content Database—together with memory linked directly to server 18
24 User Database—together with memory linked directly to server 18
26 Item Database—together with memory linked directly to server 18
28 Transactional Database—together with memory linked directly to server 18
30 Database
32 3^{rd} party Merchant Facility—capable of supporting multiple currency credit card transactions and other payment mechanisms such as Paypal and linked to Main Program Code 20 and Databases 22-30
34 A-N Multiple Escrow Accounts—Each seller listing an item or product is required to open an escrow account to facilitate holding of sales proceeds for the duration his or her item or product is listed as being for sale. Transactions to Escrow Accounts are controlled by the Main Program Code 20 and depending on the Escrow provider involve a e-commerce or Merchant Facility 34
36 3^{rd} Party Audit—professional consultant such as an attorney specialising in IP capable of auditing checklist of documentation required for Listing including verifying contracts of sale etc.
38 System Support Team—responsible for communicating with Sellers/Users 12A-12N and facilitating Listing procedure ensuring relevant documentation is uploaded and activating the Listing to go live

### DETAILED DESCRIPTION—PREFERRED EMBODIMENT

### 1. Introduction

By way of illustration only, and not by way of limitation, the present preferred embodiment refers in particular to the ownership and sale of “Intellectual Property” as the key base for this model. This is because this invention is particularly suited to raising or releasing finance in the music, media and entertainment sector for individual or business projects that are Intellectual Property based. For example this invention will enable an independent music label to raise the necessary funds to release a new album project by one of their bands.

They can achieve this without having to wait for the unlikely prospect of a commercial finance opportunity to arise by using this invention to sell multiple or plural percentages or parts or “Units” in the ownership of the Intellectual Property that will result from the production of the Master Recording. The parts or percentages or Units, will then be sold to other entities or members of the public some of whom may also be fans of the band and keen to become involved in the successful development of their preferred band. Similarly, this invention will also enable independent film makers to raise finance for new films by selling multiple or plural parts or percentages (Units) in the Intellectual Property rights of the film and associated benefits to members of the public and film fans. This method and instrument can however be applied to any property asset of which ownership and other risks can be divided into parts or Units, and which is capable of generating some form of profit stream.

### 2. Basis of the Method and Instrument

This invention specifically addresses the main barriers to funding currently faced by many small-medium sized enterprises in the creative and entertainment sector. One of the main barriers to funding or finance is the fact that commercial finance products generally available to small to medium sized enterprises involves a financial risk assessment, and frequently requires tangible assets as a form of surety. The financial profit potential of Intellectual Property based projects are often not considered, because Intellectual Property based businesses or business projects such as record producing or films are in most cases considered high-risk projects for investment purposes. This invention is based on key concepts and mechanisms that have not been used or used in combination prior to this invention in a manner capable of providing a realistic source of finance for small-medium sized enterprises.

The first key concept is that this method and instrument starts from the basis that there is a seller/owner of Intellectual Property with an established legal right to sell or transfer that right or parts thereof. Furthermore, the Intellectual Property must be either in existence already, or be about to be created. If the Intellectual Property is about to be created, the Seller/Owner must be able to provide sufficient evidence thereto and provide sufficient information on the description of the IP to be sold. This enables those acquiring rights in the Intellectual Property to participate in the management of that Intellectual Property and to benefit from any rights or benefits attached to that Intellectual Property once created, such as potential or future profit streams.

### 3. Identifiable Ownership of Intellectual Property:

There must exist an ownership right of Intellectual Property or other Asset which is identified or identifiable. The seller must be entitled to sell or transfer those rights or parts or percentages therein. As part of the process of sale, the seller is required to engage a 3^{rd} Party Consultant, such as a Lawyer to verify the ownership of the Intellectual Property that the Seller will be listing for sale and ensure that all the relevant contracts relating to that IP are correct. In effect, the seller will be submitting to a mini-audit of the Intellectual Property in question. The Seller will also be required to have the standard conditions of sale and transfer document signed, and confirm any variable terms to the standard conditions of sale in writing with this 3^{rd} Party Consultant. The Seller must also confirm in writing his arrangements enabling Buyers of Units in his IP to have a day to day involvement in the management of the Intellectual Property. This may take the form of general meetings or electronic communication. All these details are made public in the Listings material of each individual sale.

### 4. Sale of Units in the Ownership of the Intellectual Property:

On the basis that there exists a legal ownership right of a piece of Intellectual Property, this method and instrument enables the sale of parts or percentages in the ownership of Intellectual Property and associated rights or benefits. Thus an individual or business or other entity in control of an Intellectual Property and with legal right to sell or transfer such rights can raise finance from selling off parts of the Intellectual Property and/or rights therein. These parts or percentages or Units can be of an unlimited number as determined by the Seller at the start of the Listing. Units are identified via a unique identifier that is assigned to each Unit, and made known to the seller and buyer so that each Unit may be identified once it has been issued. The Units (parts or percentages) generated can be sold to multiple individual buyers. Units may represent any value of more than 0% and less than 100% of the Intellectual Property asset, for the life of that Intellectual Property or as specified in the conditions of sale.

For example, in the present embodiment a Seller looking to raise $50,000 can sell 10,000 Units representing 45% of the ownership of his Intellectual Property at $5.00 each to 10,000 individual buyers. Each individual buyer will thus have a pro-rata share representing 0.0045% of the ownership of IP (as defined in the seller contract of sale and item description). In turn, each buyer will also have 0.0045% right to any profit streams attached to the ownership of that IP. The Seller or Seller's representative is responsible for ensuring that those profit streams are disbursed to the Units holders. Clearly where a buyer is only buying a 0.0045% right in a piece of IP his involvement is of limited scale. However, this invention enables buyers to acquire substantially more Units in any item of IP sold should they so desire. A Seller is obliged to engage Buyers in his IP as they are partly investing in the performance of that IP and have pro-rata ownership rights.

### 5. Listings and Content of Sale Pages

The Seller can utilise a series of pages on the website to provide information to potential buyers. The Listing pages provide information about the sale, start and end date, item being sold and conditions of sale, Seller's details, the minimum finance amount being raised and the number of Units for sale as well as pricing information. The Listing page also provides links to a variety of content relating to the sale, such as audio and/or video files, and links to any additional material about buyer's benefits such as merchandise, gifts and benefits associated with the Units being sold. The System Support Team checks the details, documentation and content for the listing via the system and ensures that the Listing is made live at the appropriate time. The Seller's Information Pages detail information about the status of the sale, such as the number and type of Units sold, and amount of finance raised and information about Buyers.

### 6. Ownership Rights for Buyers

Buyers of these parts or percentages or Units in the Intellectual Property generally obtain a pro-rata ownership right of that IP including any associated property or ownership rights or benefits that go with the transfer of Intellectual Property Rights. The details of how profits are calculated are provided in the sale or listing details that the buyer views before making a purchase of Units. A buyer must agree to the standard terms and conditions of sale, and these include the conditions of transfer of Intellectual Property Rights. The Seller of IP will sign the transfer documents detailing the terms of the Intellectual Property transfer or assignment.

### 7. Day to Day Control of the Intellectual Property Bought

Buyers acquire pro-rata rights in the day-to day management of their Intellectual Property. The method by which they can be involved in the day to day management of their intellectual property is detailed in the buyers information documentation and in the sale listing, and contained in the terms of the contract documentation. Hence buyers in return for their investment will receive a real ownership right and a say in the day to day management of their IP.

### 8. Resale Rights

As owners of IP rights, Buyers who have bought Units in an item of IP they also have the right to sell those IP rights. Each Unit issued via the method and instrument has a unique identifier which will enable its ownership to be tracked for the lifetime of that Unit.

Buyers can re-list their Units for sale (together with any associated rights or benefits) via the method and instrument. The right to a say in the day to day management of the IP and any profits or benefits associated with those re-sold Units will transfer to the new owner of the Units.

### 9. Direct Relationship Between Buyers and Sellers

There is no requirement for an Intermediary between Sellers of Intellectual Property and Buyers of Intellectual Property. Buyers and Sellers are free to transact without interference from a 3^{rd} Party. This invention provides a means for Sellers to develop direct and long term relationships with those who have bought Units in their IP. Buyers of IP have a stake in the Sellers' IP and how they generate profits from that IP. Buyers of IP have a say in the creation of IP where they have acquired a right in the ownership of a future item of IP to be created at a future date. Depending on the conditions of sale, the Units offered and associated ownership rights last for the lifetime of the IP.

### 10. Finance

Key to this invention is the provision of finance for small-medium enterprises. The type of finance made available through this method is of similar levels to angel investment. It also enables a business or other entity to develop its business in readiness for more mainstream commercial investment.

Those seeking finance can set the terms for the finance they require such as the minimum amount and the terms of the parts or percentages, or Units sold. They are not required to relinquish control over 100% of their Intellectual Property, Property or other assets. The process will enable to them to develop a relationship with their investors and an element of accountability as they are required to enable their investors to have a share in the day to day control of the asset or property.

This invention enables small enterprises to attract small individual investors who are not looking to gain huge profits by investing in their business. Rather the ethos of this invention is for supporters of IP-based projects to provide a small element of financial ‘sponsorship’ and assistance to help their favourite IP based project to flourish, in return for a stake in the project and a potential return on their investment.

Buyer-investors are required to pay for their Units at the time of purchase, although the sale or listing will not complete until the prescribed period of listing has ceased. Units can be bought in a number of currencies, via credit card or other e-merchant method supported by the e-commerce or merchant facility.

### 10.a Escrow Bank Account

In order to safe-guard investors' money, some checks have been put in place. All funds generated from sales of Units in IP are paid into an individual Escrow bank account linked to the sale. The terms of the Escrow account reflect the terms of sale. Where a sale does not succeed in generating the required amount of financing stated, (for instance, which would be the minimum to make a project work) the seller has the option to cancel the sale and return the funds to the buyer-investors via the Merchant facility.

Where the sale succeeds in raising the required amount of finance, the funds are released in 3 or more stages from the Escrow Account (in the case of an IP project that will result of the finance raised via the invention) in line with the key business milestones for that IP-based project. For instance for a record, pre-production, production and distribution/marketing. This will enable the seller to engage the buyer-investor during the lifetime of the project with regards to major decisions in the development of that project.

### 11. Selling 3^{rd} Party Rights

Units bought on other (future) 3^{rd} party systems can be sold via the invention where the ownership can be traced to an existing IP right. (At present such 3^{rd} party systems do not yet exist).

### 12. Exemplary Method for Buying and Selling Units

FIG. 1 shows the overall architecture of the method and instrument for buying and selling parts or percentages or Units in Intellectual Property rights (or other asset-based rights), and for selling such Units originating from other 3^{rd} party systems. For ease of reference the 3 main processes in this method and instrument have been illustrated separately as Selling, Buying and Tracking of Units. FIG. 1A is a flow chart showing the Seller-User operation of the preferred embodiment detailing the basic mechanisms involved in the process. FIG. 1B is a flow chart showing the Buyer-User operation of the preferred embodiment.

### 12.A. Selling

A seller accesses the GUI 10 via his Individual Information Appliance 14A-14N and receives registration instructions via the GUI 10 and transmits his personal details via the GUI into the relevant Database 22-30 on the Webserver 18. The system prompts a registration page to appear on his web interface via the GUI 10. (The GUI 10 is generated by the main program which sits on the web-server and the information that each user sees is generated dynamically i.e. its different on every single occasion by the main program which interrogates the Databases 22-30 in real time and presents or displays the information to the user via the GUI 10).

The Item Description page is generated enabling him to input this own details & item details and this can include documentations such as marketing material, audio and video material files such as music tracks or film shorts these transmitted via the GUI 10 directed by the Main Program Code into the relevant Database (Item Data 26). On completion of these details the Webserver 18 generates a message to the seller instructing the seller to obtain an Audit of the materials on sale via a 3^{rd} Party Audit consultant 36.

On completion of the 3^{rd} party audit checklist (which will usually include a signed transfer or sale document) seller uploads requested documents from the 3^{rd} party audit process via email or utilising the GUI 10 to upload into the Database 22-30 (via email or other form)

A manual check is carried out by the System Support team 38 to insure that the documents verify the product description and all relevant documents are provided.

At an agreed time, the sale or “the Listing” goes live for a prescribed period of time (often 3 months, but can be more or less). The Live sale page enables site visitors to obtain information about the seller and the product but more importantly enables buyers to buy “Units” our terminology for percentages of the item, rather than the whole item.

Each Unit has its own serial number, or “unique identification number” generated by and held in the database and any amount of more than 0% to normally less than 100% can be bought by a buyer. The Listings page is created in real time each time a viewer access it via the GUI 10.

The seller receives a notification via email and also the information will appear in their dedicated sellers information pages on the website (“MY Account Pages”) dedicated to providing records of all transactions that can only be accessed by the seller and the system administrator a Unit (or Units ) have been bought. The buyer decides to make a purchase and clicks on the ‘buy’ function and is then given an electronic invoice (webpage or email) to pay, which he will pay using an integrated 3^{rd} Party Merchant 32.

The funds are then transferred electronically by the 3^{rd} Party Merchant into the seller's Escrow bank Account 34A-N. When Units are purchased, the buyer receives a digital confirmation that they are the owner of that uniquely numbered Unit (or Units).

When the Listing finishes at the prescribed time the seller has the option of cancelling the transactions if he is not satisfied with the results of the sale and refunding any amounts. This is made possible by either cancelling each transaction individually or all of the Units purchased of that item in one function in his dedicated sellers information pages additionally the seller will need to use the 3^{rd} Party Merchant account 32 to refund each of the buyers separately

In the event the sale is not cancelled, the money is transferred from the relevant Escrow Account 34A-N to the seller's nominated account, and the seller can utilise the funds. The funds may be released in tranches via the Escrow Account 34A-N as determined by the conditions of sale of some items.

A Seller can also use the method and instrument to list Units generated or acquired via other 3^{rd} Parties in the same process as a Buyer reselling Units.

### 12.B. Buying

A site visitor can view information about items for sale and associated benefits and/or rights, utilising the GUI 10 which is sent by the Main Program Code 20, information about products that is contained in the relevant Database 22-30 on the server. In the event that site visitor wishes to buy a Unit or Units in an Item, selects the ‘buy function’ which will prompt the system to instruct him to register first. The Buyer will then need to register on the registration page and confirm their acceptance of the system's Terms and Conditions and Standard Conditions of Sale and provide a specified email address—the user is given a unique identifier to identify their transactions and any activity within the system generated by that particular user.

After registration, the Buyer can initiate the purchase of a Unit or Units. Depending on the sale type, it may be a fixed amount, or a bidding process. The seller accepts the offer. In some cases the acceptance of offer to buy can be generated automatically via the GUI 10. In terms of the Buyers acceptance of the Sellers terms and conditions this is done either via the items descriptions or a separate prompt to specifically confirm that they have read the terms and conditions of sale and agreed to them prior to completing the sale.

The Buyer is presented with an electronic invoice which directs them to make payment via a 3^{rd} Party Merchant 32; this information is also on their dedicated buyers information pages; they can opt to pay in a selection of major currencies via the 3^{rd} Party Merchant by credit card or e-transfer or other means. They receive digital confirmation which is a Digital Proof of Purchase via their specified email address and a Digital Proof of Purchase will be recorded on their dedicated buyers information pages and both of these digital proof of purchases will serve as legal proof of ownership of the Unit(s) purchased. Both of these will also contain a copy of the Agreement of Sale or Transfer signed by the Seller detailing the Terms and Conditions.

At this stage, the sale is not complete until the seller's prescribed sale period finishes, at which point the seller has a specified amount of time in which he can cancel the sale. In the event that the sale is not cancelled the Buyer then becomes the owner of the Unit(s) and any associated rights or benefits. The Buyer will receive any profits associated with his Units directly from the seller or seller's representatives outside of the system. In the event that the Buyer decides that he would like to subsequently sell some Units that he has purchased he can utilise the same process to sell the Units as the Seller originally utilised excepting for minor differences such as the fact that the Buyer-Seller (secondary seller) will not need to obtain the 3^{rd} party documents as these are already available within the item description on the system. Buyers can re-sell on the system using the same process as the original seller but he will not require to provide 3^{rd} party audit documentation.

### 12.C. Tracking

FIG. 1C is a flow chart of the Performance Tracking operation of the preferred embodiment. There is a section on the GUI 10 that displays information to help people track the number of sales, offered prices for purchase and other key indicators of sales on the system. This information is generated via the Databases on the Webserver 18.

It will be appreciated by those of ordinary skill in the art that the invention can be embodied in other specific forms without departing from the spirit or essential character thereof. The present invention is therefore considered in all respects to be illustrative and not restrictive. The scope of the invention is indicated by the appended claims, and all changes that come within the meaning and range of equivalents thereof are intended to be embraced therein.

### OPERATION OF PREFERRED EMBODIMENT

FIG. 1 shows the overall architecture for the preferred embodiments of the system on the basis of an on-line database driven, Content Management System (CMS). In Operation, participants such as Users 12A-N, System Support Team 38, 3^{rd} Party Merchant 32, Escrow Account Managers 34A-N and 3^{rd} Party Audit consultants 36 connect via a Graphic User Interface (“GUI”) 10 generally over the internet.

The GUI 10 is generated by the Main Program Code 20 which sits on the web-server and the information that each user (Users 12A-N and System Support Team 38) sees is generated dynamically i.e. it is different on every single occasion, by the Main Program 20 which interrogates the Databases 22-30 in real time and presents or displays this information to the user via the GUI 10.

So for an unregistered user, the information will include information from the Content Database 22, from the Item Description 26 and some limited data from the User Database 24 about other Users 12A-N (and System Support Team 38) and transactions.

Once registered into the system the user 12A-N will get more extensive information about other Users 12A-N and other transactions but will also be able to store and save information regarding their own use of the system and any items they are “watching” or buying or selling.

Sub-routines in the Program register users and facilitates the transactions and invoicing.

The GUI 10 interacts with the Main Program Code 20 to send transaction details to the Merchant Facility 32 and relevant Escrow Account (s) 34A-N and then to the Databases 22-30.

Where necessary due to the level of transactions and data being generated, the system can be hosted on several different servers such as a separate server for registration and a separate server for to protect other data. Similarly, all the functions could be carried out on a single server, depending on the configuration.

This invention can be applied in many different industry sectors for the purpose of raising finance or providing funding. The key basis is an underlying asset of some form with a legitimate ownership and that ownership must be capable of being divided into meaningful parts or portions in the manner of this method. Hence this invention can lend itself for instance to generating finance for small-medium sized and micro enterprises in developing nations. The inventors have considered the requirements in such case and this method and instrument can be managed on an off-line system, for instance in geographical areas where it is difficult to have on-line access. Clearly there will be a requirement for the system to be marketed and managed sufficiently to enable public participation when in an off-line form.

Alternative Embodiment B below describes such an offline embodiment.

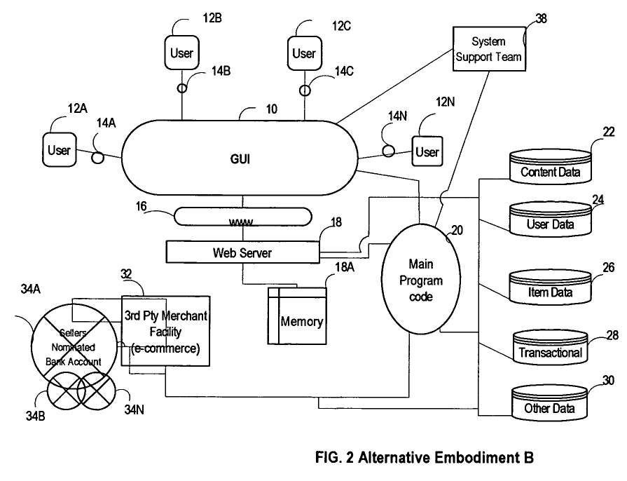

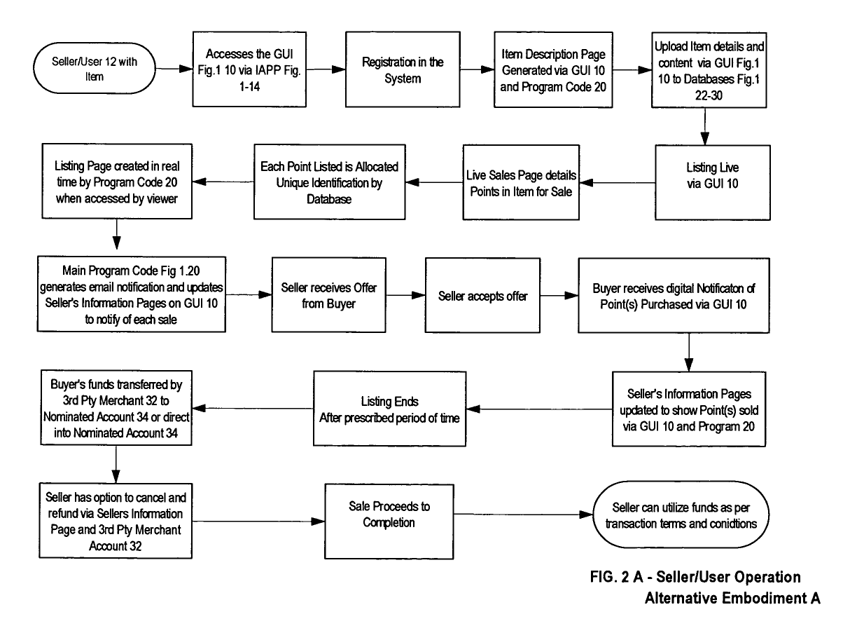

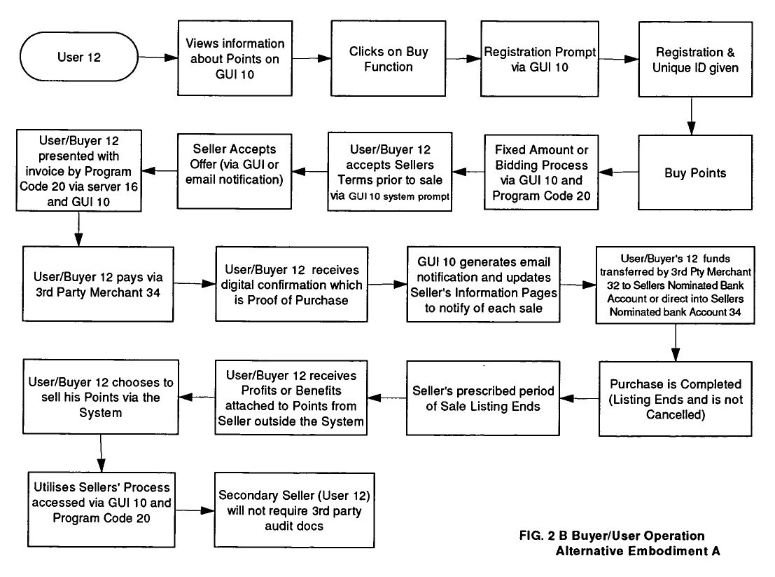

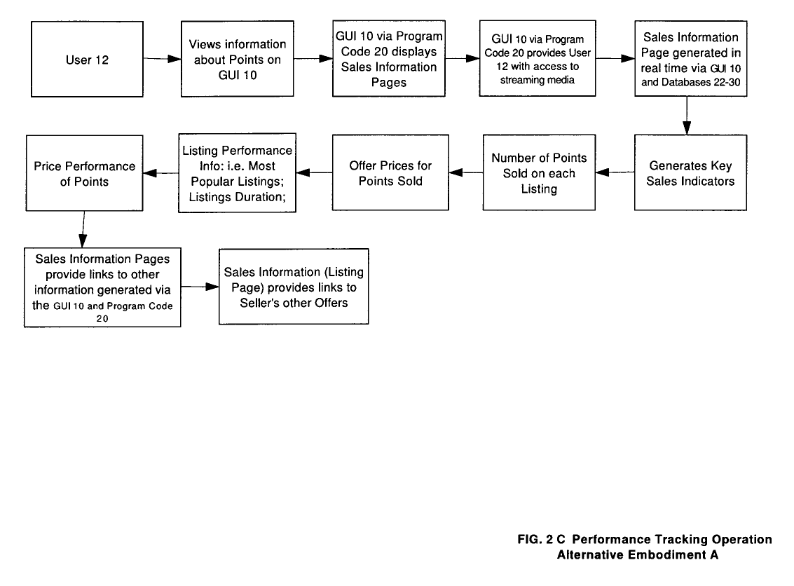

### DRAWINGS—REFERENCE NUMERALS FIG. 2

10 Graphic User Interface (GUI)
12A-N Multiple Users—connected via the GUI over the internet by means of 14 A-N
14 A-N Individual Information Appliance—users connect to the GUI by means of an appliance such as a general purpose computer with a display and memory or PDA capable of connecting to the internet and supporting a browser for surfing the internet
16 WWW—world wide web 16 forming the connection between the web server 18 and the GUI 10
18, 18A Web Server—hosting the main program and containing sufficient memory 18A for hosting the main program and capable of interrogating the databases 22-30
20 Main Program code—(such as PHP or Pearl or other suitable language) capable of communicating with, interrogating and receiving information from databases 22-30.
22 Content Database—together with memory linked directly to server 18
24 User Database—together with memory linked directly to server 18
26 Item Database—together with memory linked directly to server 18
28 Transactional Database—together with memory linked directly to server 18
30 Database
32 3^{rd} party Merchant Facility—capable of supporting multiple currency credit card transactions and other payment mechanisms such as Paypal and linked to Main Program Code 20 and Databases 22-30
34 A-N Multiple Sellers Nominated Bank Accounts—Each seller listing nominates a bank or electronic banking account. Transactions to these accounts are controlled by the Main Program Code 20 and depending on the provider involve an e-commerce or Merchant Facility 34
38 System Support Team—responsible for communicating with Sellers/Users 12A-12N and facilitating Listing procedure ensuring relevant documentation is uploaded and activating the Listing to go live

### DETAILED DESCRIPTION—ALTERNATIVE EMBODIMENT A

### 1. Introduction

As with the preferred embodiment above, by way of illustration only, and not by way of limitation, the present Alternative Embodiment A refers in particular to the ownership and sale of “Intellectual Property” as the key base for this model. This is because this invention is particularly suited to raising or releasing finance in the music, media and entertainment sector for individual or business projects that are Intellectual Property based. For example this invention will enable an independent music label to raise the necessary funds to release a new album project by one of their bands.

They can achieve this without having to wait for the unlikely prospect of a commercial finance opportunity to arise by using this invention to sell multiple or plural percentages or parts or “Units” in the ownership of the Intellectual Property that will result from the production of the Master Recording. The parts or percentages or Units, will then be sold to other entities or members of the public some of whom may also be fans of the band and keen to become involved in the successful development of their preferred band. Similarly, this invention will also enable independent film makers to raise finance for new films by selling multiple or plural parts or percentages (Units) in the Intellectual Property rights of the film and associated benefits to members of the public and film fans. This method and instrument can however be applied to any property asset of which ownership and other risks can be divided into parts or Units, and which is capable of generating some form of profit stream.

### 2. Basis of the Method and Instrument

This invention specifically addresses the main barriers to funding currently faced by many small-medium sized enterprises in the creative and entertainment sector. One of the main barriers to funding or finance is the fact that commercial finance products generally available to small to medium sized enterprises involves a financial risk assessment, and frequently requires tangible assets as a form of surety. The financial profit potential of Intellectual Property based projects are often not considered, because Intellectual Property based businesses or business projects such as record producing or films are in most cases considered high-risk projects for investment purposes. This invention is based on key concepts and mechanisms that have not been used or used in combination prior to this invention in a manner capable of providing a realistic source of finance for small-medium sized enterprises.

The first key concept is that this method and instrument starts from the basis that there is a seller/owner of Intellectual Property with an established legal right to sell or transfer that right or parts thereof. Furthermore, the Intellectual Property must be either in existence already, or be about to be created. If the Intellectual Property is about to be created, the Seller/Owner ideally should be able to provide sufficient evidence thereto and provide sufficient information on the description of the IP to be sold. This enables those acquiring rights in the Intellectual Property to benefit from any rights or benefits attached to that Intellectual Property once created, such as potential or future profit streams.

### 3. Sale of Units in the Ownership of the Intellectual Property:

On the basis that there exists a legal ownership right of a piece of Intellectual Property, this method and instrument enables the sale of parts or percentages in the ownership of Intellectual Property and associated rights or benefits. Thus an individual or business or other entity in control of an Intellectual Property and with legal right to sell or transfer such rights can raise finance from selling off parts of the Intellectual Property and/or rights therein. These parts or percentages or Units can be of an unlimited number as determined by the Seller at the start of the Listing. Units are identified via a unique identifier that is assigned to each Unit, and made known to the seller and buyer so that each Unit may be identified once it has been issued. The Units (parts or percentages) generated can be sold to multiple individual buyers. Units may represent any value of more than 0% and less than 100% of the Intellectual Property asset, for the life of that Intellectual Property or as specified in the conditions of sale.

For example, in the present embodiment a Seller looking to raise $50,000 can sell 10,000 Units representing 45% of the ownership of his Intellectual Property at $5.00 each to 10,000 individual buyers. Each individual buyer will thus have a pro-rata share representing 0.0045% of the ownership of IP (as defined in the seller contract of sale and item description). In turn, each buyer will also have 0.0045% right to any profit streams attached to the ownership of that IP. The Seller or Seller's representative is responsible for ensuring that those profit streams are disbursed to the Units holders. Clearly where a buyer is only buying a 0.0045% right in a piece of IP his involvement is of limited scale. However, this invention enables buyers to acquire substantially more Units in any item of IP sold should they so desire.

### 4. Listings and Content of Sale Pages

The Seller can utilise a series of pages on the website to provide information to potential buyers. These pages should ideally be used by the seller to provide information about the sale, start and end date, item being sold and conditions of sale, Seller's details, the minimum finance amount being raised and the number of Units for sale as well as pricing information. The pages can also provides links to a variety of content relating to the sale, such as audio and/or video files, and links to any additional material about buyer's benefits such as merchandise, gifts and benefits associated with the Units being sold.

### 5. Resale Rights

Buyers should be allowed to sell the Units or rights they have purchased.

### 6. Direct Relationship Between Buyers and Sellers

There is no requirement for an Intermediary between Sellers of Intellectual Property and Buyers of Intellectual Property. Buyers and Sellers are free to transact without interference from a 3^{rd} Party. This invention provides a means for Sellers to develop direct and long-term relationships with those who have bought Units in their IP.

### 7. Finance

This invention can help to provide finance for small-medium enterprises. The type of finance made available through this method is of similar levels to investment referred to as Angel investment. It also enables a business or other entity to develop its business in readiness for more mainstream commercial investment.

Utilising this invention, those seeking finance can set the terms for the finance they require such as the minimum amount and the terms of the parts or percentages, or Units sold. They are not required to relinquish control over 100% of their Intellectual Property, Property or other assets. The process will enable to them to develop a relationship with their investors if they choose.

Units can be bought in a number of currencies, via credit card or other e-merchant method supported by the e-commerce or merchant facility.

### 8. Selling 3^{rd} Party Rights

Units bought on other (future) 3^{rd} party systems can be sold via the invention where the ownership can be traced to an existing IP right. (At present such 3^{rd} party systems do not yet exist).

### 9. Exemplary Method for Buying and Selling Units

FIG. 2 shows the overall architecture of the method and instrument for buying and selling parts or percentages or Units in Intellectual Property rights (or other asset-based rights), and for selling such Units originating from other 3^{rd} party systems. For ease of reference the 3 main processes in this method and instrument have been illustrated separately as Selling, Buying and Tracking of Units. FIG. 2A is a flow chart showing the Seller-User operation of Alternative Embodiment A, detailing the basic mechanisms involved in the process. FIG. 2B a flow chart showing the Buyer-User operation of the preferred embodiment.

### 12.A. Selling

A seller accesses the GUI 10 via his Individual Information Appliance 14A-14N and receives registration instructions via the GUI 10 and transmits his personal details via the GUI into the relevant Database 22-30 on the Webserver 18. The system prompts a registration page to appear on his web interface via the GUI 10. (The GUI 10 is generated by the main program which sits on the web-server and the information that each user sees is generated dynamically i.e. its different on every single occasion by the main program which interrogates the Databases 22-30 in real time and presents or displays the information to the user via the GUI 10).

The Item Description page is generated enabling him to input this own details & item details and this can include documentations such as marketing material, audio and video material files such as music tracks or film shorts these transmitted via the GUI 10 directed by the Main Program Code into the relevant Database (Item Data 26).

At a time specified by the seller, the sale or “the Listing” goes live for a prescribed period of time (often 3 months, but can be more or less). The Live sale page enables site visitors to obtain information about the seller and the product but more importantly enables buyers to buy “Units” our terminology for percentages of the item, rather than the whole item.

Each Unit has its own serial type number, or “unique identification number” generated by and held in the database and any amount of more than 0% to normally less than 100% can be bought by a buyer. The Listings page is created in real time each time a viewer access it via the GUI 10.

The seller receives a notification via email and also the information will appear in their dedicated sellers information pages on the website (“MY Account Pages”) dedicated to providing records of all transactions that can only be accessed by the seller and the system administrator a Unit (or Units ) have been bought.

The buyer decides to make a purchase and clicks on the ‘buy’ function and is then given an electronic invoice (webpage or email) to pay, which he can will most likely pay using an integrated 3^{rd} Party Merchant 32.

The funds are then transferred electronically by the 3^{rd} Party Merchant to sellers nominated bank account 34A-N. When Units are purchased, the buyer receives a digital confirmation that they are the owner of that uniquely numbered Unit (or Units).

When the Listing finishes at the prescribed time the seller has the option of cancelling the transactions if he is not satisfied with the results of the sale and refunding any amounts. This is made possible by either cancelling each transaction individually or all of the Units purchased of that item in one function in his dedicated sellers information pages additionally the seller will need to use the 3^{rd} Party Merchant account 32 to refund each of the buyers separately

In the event the sale is not cancelled, the seller can utilise the funds.

A Seller can also use the method and instrument to list Units generated or acquired via other 3^{rd} Parties in the same process as a Buyer reselling Units.

### 12.B. Buying

A site visitor can view information about items for sale and associated benefits and/or rights, utilising the GUI 10 which is sent by the Main Program Code 20, information about products that is contained in the relevant Database 22-30 on the server. In the event that site visitor wishes to buy a Unit or Units in an Item, selects the ‘buy function’ which will prompt the system to instruct him to register first. The Buyer will generally then need to register on the registration page and confirm their acceptance of the system's Terms and Conditions and Standard Conditions of Sale and provide a specified email address—the user is given a unique identifier to identify their transactions and any activity within the system generated by that particular user.

After registration, the Buyer can initiate the purchase of a Unit or Units. Depending on the sale type, it may be a fixed amount, or a bidding process. The seller accepts the offer. In some cases the acceptance of offer to buy can be generated automatically via the GUI 10. In terms of the Buyers acceptance of the Sellers terms and conditions, in the event that this is required, this is done either via the items descriptions or a separate prompt to specifically confirm that they have read the terms and conditions of sale and agreed to them prior to completing the sale.

The Buyer is presented with an electronic invoice which directs them to make payment via a 3^{rd} Party Merchant 32; this information is also on their dedicated buyers information pages; they can opt to pay in a selection of major currencies via the 3^{rd} Party Merchant by credit card or e-transfer or other means. They receive digital confirmation which is a Digital Proof of Purchase via their specified email address and a Digital Proof of Purchase will be recorded on their dedicated buyers information pages and both of these digital proof of purchases will serve as legal proof of ownership of the Unit(s) purchased. Both of these may also contain a copy of the Agreement of Sale or Transfer signed by the Seller detailing the Terms and Conditions.

At this stage, the sale may be completed or may not complete until a period of time prescribed by the seller elapses, at which point the seller has a specified amount of time in which he can cancel the sale. In the event that the sale is not cancelled the Buyer then becomes the owner of the Unit(s) and any associated rights or benefits. The Buyer will receive any profits associated with his Units directly from the seller or seller's representatives outside of the system. In the event that the Buyer decides that he would like to subsequently sell some Units that he has purchased he can utilise the same process to sell the Units as the Seller originally utilised excepting for minor differences. Buyers can re-sell on the system using the same process as the original seller but he will not require to provide 3^{rd} party audit documentation.

### 12.C. Tracking

FIG. 2C is a flow chart of the Performance Tracking operation of the preferred embodiment. There is a section on the GUI 10 that displays information to help people track the number of sales, offered prices for purchase and other key indicators of sales on the system. This information is generated via the Databases on the Webserver 18.

It will be appreciated by those of ordinary skill in the art that the invention can be embodied in other specific forms without departing from the spirit or essential character thereof. The present invention is therefore considered in all respects to be illustrative and not restrictive. The scope of the invention is indicated by the appended claims, and all changes that come within the meaning and range of equivalents thereof are intended to be embraced therein.

### OPERATION OF ALTERNATIVE EMBODIMENT A

FIG. 2 shows the overall architecture for the preferred embodiments of the system on the basis of an on-line database driven, Content Management System (CMS). In Operation, participants such as Users 12A-N, System Support Team 38, 3^{rd} Party Merchant 32 connect via a Graphic User Interface (“GUI”) 10 generally over the internet.

The GUI 10 is generated by the Main Program Code 20 which sits on the web-server and the information that each user (Users 12A-N and System Support Team 38) sees is generated dynamically i.e. it is different on every single occasion, by the Main Program 20 which interrogates the Databases 22-30 in real time and presents or displays this information to the user via the GUI 10.

So for an unregistered user, the information will include information from the Content Database 22, from the Item Description 26 and some limited data from the User Database 24 about other Users 12A-N and transactions.

Once registered into the system the user 12A-N will get more extensive information about other Users 12A-N and other transactions but will also be able to store and save information regarding their own use of the system and any items they are “watching” or buying or selling.

Sub-routines in the Program register users and facilitate the transactions and invoicing.

The GUI 10 interacts with the Main Program Code 20 to send transaction details to the Merchant Facility 32 and then to the Databases 22-30.

Where necessary due to the level of transactions and data being generated, the system can be hosted on several different servers such as a separate server for registration and a separate server for to protect other data. Similarly, all the functions could be carried out on a single server, depending on the configuration.

This invention can be applied in many different industry sectors for the purpose of raising finance or providing funding. The key basis is an underlying asset of some form with a legitimate ownership and that ownership must be capable of being divided into meaningful parts or portions in the manner of this method. Hence this invention can lend itself for instance to generating finance for small-medium sized and micro enterprises in developing nations. The inventor has considered the requirements in such case and this method and instrument can be managed on an off-line system, for instance in geographical areas where it is difficult to have on-line access. Clearly there will be a requirement for the system to be marketed and managed sufficiently to enable public participation when in an off-line form.

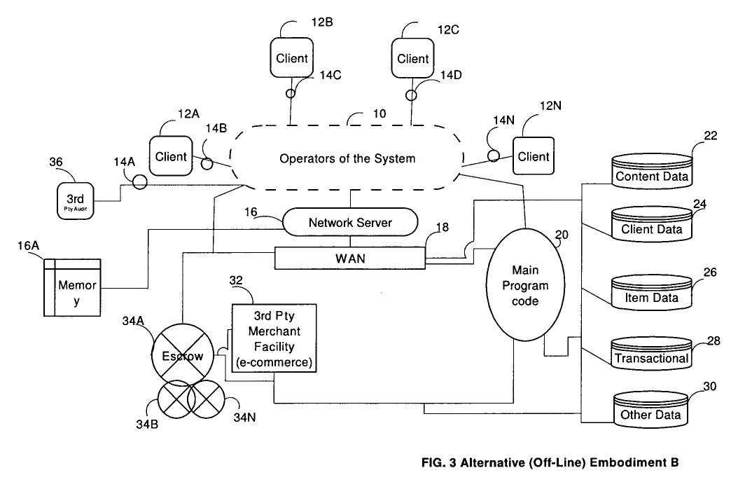

FIG. 3 shows an example of such an off-line method as an ALTERNATIVE EMBODIMENT B of the invention.

### DRAWINGS—REFERENCE NUMERALS FIG. 3

Number Description
10 Operators of the System able to liase with Clients 12A-C and able to access the system Network Server 16 via the Wide Area Network 18 and Main Program Code 20
12A-N Clients (buyers, sellers and enquirers) access the system by contacting the Operators of the System 10 via a variety of different forms of communication, determined by local norms, for instance in person, or via facsimile, telephone, post or email
14 A-N Individual Communication Device—Clients connect to the Operators of the System by means of a device such as a fax machine or telephone (or in person) in order to access the system and buy or sell Units and obtain general information
16 Network Server that forms part of the WAN 18 and containing sufficient memory to 16A to host the main Program Code 20
18 Wide Area Network of inter-dependent computers accessed by the Operators of the System and linked to a Server 16
20 Main Program Code (such as PHP or Pearl or other suitable language) capable of communicating with, interrogating and receiving information from databases 22-30.
22 Content Database 22 together with memory linked directly to Server 16
24 Clients Database 24 together with memory linked directly to Server 16
26 Item or Product Database 26 together with memory linked directly to Server 16
28 Transactional Database 28 together with memory linked directly to Server 16
30 Database Miscellaneous 30 together with memory linked directly to Server 16
32 3^{rd} party merchant facility capable of supporting multiple currency credit card transactions and other payment mechanisms such as Paypal and independently accessible by Operators of the System 10 or via the Network Server 16 utilising the Main Program Code 20
34 A-N Multiple Escrow Accounts—In most cases each seller listing an item or product is required to open an escrow account to facilitate holding of sales proceeds for the duration his or her item or product is listed as being for sale. The Escrow Accounts are independently accessible by the Operators of the System 10 and or via the Network Server 16 utilising the Main Program Code 20
36 3^{rd} Party Audit—an external professional consultant (for instance lawyer familiar with intellectual property law) able to provide an audit of the items to be listed for sale and able to provide required listing documentation that are required to be submitted by a User-Seller 12 to the Operators of the System 10 who will carry out a manual or on-line check of the documentation

### DETAILED DESCRIPTION—ALTERNATIVE EMBODIMENT B (OFF-LINE)

This method and instrument utilises an off-line, database driven, Content Management System (CMS)

### 1. Clients (Buyers, Sellers and Enquirers)

The Clients 12-12N connect via their Individual Communication Device 14-14N to the Operators of the System 10

### 2. Buying, Selling and Information Gathering

Operators of the System (“OOTS”) 10 accesses the Main Program Code 20 which sits on a Server 16 forming part of the Wide Area Network 18 and the information seen by the OOTS 10 is generated dynamically i.e. its different on every single occasion depending on the transaction being carried out, by the Main Program Code 20 which interrogates the Databases 22-30 in real time and presents or displays this information to OOTS 10 via a computer and display linked to the WAN 18.

The OOTS can provide general information to the Client 12 from the Content Database 22 from the item description and Information Database 25 and some limited data from the Client Database 24 and the Transactional Database 28 about other Clients and other transactions. Once registered into the system the OOTS 10 will be able to provide more extensive information about other Clients and other transactions.

A sub-routine in the programme enables the OOTS 10 to register Clients and facilitate Client buying and selling transactions and invoicing.

### 3. Payment and Financial Transactions

The Operators of the System 10 interact with the Main Program Code 20 via the WAN 18 to send transaction details to Merchant Facility 32 and relevant Escrow account 34A-N and then to the Databases 22-30 or alternatively access them direct via a means of a communication device such as fax or telephone. Thus purchases and payments can be facilitated off-line.

### OPERATION OF ALTERNATIVE EMBODIMENT B

Where it is not possible to use the system by means of a Main Program Code 20 and central Server 16, all the relevant functions of the system can occur off-line. This would be enabled via a Wide Area Network 18. The Wide Area Network 18 would link to a number of communication devices and computers with memory of sufficient capability to carry out the functions of the system off-line utilising individual programs and functionality controls and storing the relevant Databases 22-30 in one or several linked computers. The OOTS 10 would access and log the relevant information and perform the necessary transactions including generating the Unique Identifier for each Unit issued via the off-line system. The OOTS 10 would maintain up to date records of any transactions in the linked Databases. (If necessary this off-line system could be operated with the aid of Agents to facilitate communication between Clients 12A-N and the Operator of the System 10. In practice this would be very onerous and would move away from the spirit of this invention to avoid any form of ‘middle man’ for those looking to sell their asset and to raise finance).

### CONCLUSION, RAMIFICATION, SCOPE

Thus the reader will see that this method and instrument provides a much needed and realistic means for small to medium sized enterprises, individuals and other entities to raise finance from other individuals or entities. There is no requirement for an intermediary financial institution. Investors are free to choose to invest only a minimal amount and can invest in as many intellectual property based projects as they wish. Furthermore, investors actually own the part or percentage, of intellectual property they have bought including any associated rights or benefits, and they have a pro-rata right to take part in the day to day management of that intellectual property they have bought.

While my above description contains many specificities, these should not be construed as limitations on the scope of the invention, but rather as an exemplification of one preferred embodiment thereof. Many other variations are possible. For example, the method and instrument can be applied to the ownership of any asset that is capable of being divided into multiple parts or percentages, and that may have a profit stream or some other benefit attached to those parts or percentages, such as real estate assets or land. In its preferred embodiments, the method and instrument are based on a database driven, content management system.

However, this method and instrument can be translated off-line in those territories where it is difficult or onerous to operate part of, or the entire system on-line, as long as the key mechanisms, controls and functions of the instrument and method remain. Although this invention is aimed at the creative and entertainment sector, it is entirely suited to be used in many other industry fields also, such as Biotechnology and Information Technology. Accordingly, the scope of the invention should be determined not by the embodiment(s) illustrated, but by the appended claims and their legal equivalents.

I claim:

1. A method for entities, including individuals and businesses, to raise finance, comprising;
(a) dividing assets, including intellectual property, property, rights in said intellectual property and said property, and revenue streams in said intellectual property and said property and said rights, into a plurality of units, including parts, portions, percentages and pieces
(b) generating unique identifiers for said units
(c) enabling the selling of a plurality of said units to a plurality of buyers
whereby the raising of funds by selling a plurality of units to a plurality of buyers substantially solves a number of business problems, including the lack of funding and finance available for entrepreneurs

2. The method of claim 1 further including providing a means, including a computer program, for buyers and sellers and operators of the system to communicate with one another and to access information regarding said assets and said units.

3. The method of claim 1 further including providing a means for buyers and sellers to transact via a third party transaction mechanism.

4. The method of claim 1 further including providing a means, including a database, for storing information about said assets and said units.

5. The method of claim 1 further including providing a first means, including a computer program, for buyers and sellers and operators of the system to communicate with one another and to access information regarding said assets and said units, and further including providing a second means for buyers and sellers to transact via a third party transaction mechanism, and further including providing a third means, including a database, for storing information about said assets and said units.

6. A method for entities to profit from buying and selling units, including parts, portions, percentages and pieces, of assets, including intellectual property, property, rights in said intellectual property and said property, and revenue streams in said intellectual property and property and said rights, comprising;
(a) providing a first means for presenting information about a plurality of said units
(b) providing a second means, including a computer program, for buyers and sellers and operators of the system to communicate with one another and to access information regarding said assets and said units
(c) providing a third means for enabling the buying and selling of said units to a plurality of buyers
whereby the raising of funds by selling a plurality of said units to a plurality of said buyers substantially solves a number of business problems, including the lack of funding and finance available for entrepreneurs.

7. The method and system of claim 6 wherein said entities includes individuals, businesses and other entities.

8. The method and system of claim 6 further including providing a means for dividing said assets into units.

9. The method and system of claim 6 further including generating unique identifiers for said units.

10. The method and system of claim 6 further including providing a means for buyers and sellers to transact via a third party transaction mechanism.

11. The method and system of claim 6 wherein said entities includes individuals, businesses and other entities and further including providing a first means for dividing said assets into units and further including providing a second means for generating unique identifiers for said units.

12. The method and system of claim 6 wherein said entities includes individuals, businesses and other entities and further including providing a first means for dividing said assets into units and further including providing a second means for generating unique identifiers for said units and further including providing a third means for buyers and sellers to transact via a third party transaction mechanism.

13. A machine for a plurality of users, including individuals, businesses and other entities, to buy and sell and otherwise trade a plurality of units, which said units include parts, percentages, pieces and other portions of assets, which said assets include intellectual property, other property, rights in said intellectual property and said other property, and any revenue stream generated by said intellectual property and said property and said rights, comprising;
(a) a database, including a number of databases of any usable format or language, for storing information about said assets and said units and said users
(b) a main computer code, which may include a number of computer codes, programs, and scripts of any language, for enabling communication to and from and between said users and other said users and said databases and the operators of the system, capable of communicating, including transmitting, sending, and interrogating, said information and offers to purchase, and negotiate, and sell and trade, and rejection of said offers to purchase, and negotiate, and to sell and trade, and acceptance of said offers to purchase, and to negotiate, and to sell and to trade, and counter offers, qualifying questions, and any other statements, ideas, questions, queries answers, and notions
(c) a memory, which includes digital and other memory, for storing temporary and permanent data
(d) a server, which includes a computer server and servers and other devices of any usable type and format and utilising any applicable format, and any applicable language, such as unix, linux, and windows, capable of providing storage, including hosting, space, room, environment and otherwise holding, said databases and said main computer code and said memory
whereby said server with said memory hosts said main computer code and said database, and said main computer code enables said communication to and from and between said users and said database and said operators of the system, to enable said users to trade, including buying and selling, said units in said assets from other said users and thereby raise funds, thus enabling substantial solutions to a multitude of problems including the on-going business and economic problem of the lack of business finance available to many small businesses, and providing a vehicle for the general public to profit by directly investing in projects.

14. The machine of claim 13 further including an additional computer code capable of enabling said communication to and from and between said users who are accessing said communication and said information via an interface device, including a graphic user interface and other digital devices, connected over a network, including the internet, the world wide web, and other networks.

15. The machine of claim 13 further including an additional computer code capable of enabling and integrating said communication with external systems and third parties such that payments can be made from one said user to another said user.

16. The machine of claim 13 further including an additional computer code capable of generating and adding to said information, a unique identifier and processing and adding to said information specific details about specific said units, including specific definitions as to how to divide specific said assets into their specific said units, and the relationship between specific said assets and their specific said units.

17. The machine of claim 13 further including an additional computer code capable of accepting additional details, including documents and commentaries and opinions, from third parties, and adding these to the said information.

18. The machine of claim 13 further including an additional computer code capable of communicating, including transmitting, sending and otherwise communicating, video and audio files such that they can be viewed by said users via a device connected to a network, including the internet and other networks.

19. The machine of claim 13 further including additional computer codes capable of enabling said communication to and from and between said users who are accessing said communication and said information via an interface device, including a GUI and other digital devices, connected over a network, including the internet, the world wide web, and other networks, and capable of enabling and integrating said communication with external systems and third parties such that payments can be made from one said user to another said user and capable of generating and adding to said information, a unique identifier and processing and adding to said information specific details about specific said units, including specific definitions as to how to divide specific said assets into their specific said units, and the relationship between specific said assets and their specific said units.

20. A method for a plurality of users, including individuals, businesses and other entities, to buy and sell and otherwise trade a plurality of units, which said units include parts, percentages, pieces and other portions of assets, which said assets include intellectual property, other property, rights in said intellectual property and said other property, and any revenue stream generated by said intellectual property and said property and said rights, comprising;
(a) providing a first means for storing information, including a number of databases of any usable format or language, for storing information about said assets and said units and said users
(b) providing a second means for enabling communication, including a main computer code, a number of computer codes, programs, and scripts of any language, for enabling communication to and from and between said users and said databases and the operators of the system, capable of communicating, including transmitting, sending, interrogating and otherwise communicating, said information and offers to purchase, and negotiate, and sell and trade, and rejection of said offers to purchase, and negotiate, and to sell and trade, and acceptance of said offers to purchase, and to negotiate, and to sell and to trade, and counter offers, qualifying questions, and any other statements, ideas, questions, queries answers, and notions
(c) providing a memory, which includes a digital and other memory, for storing temporary and permanent data
(d) providing a third means for holding said first means and said second means and said memory, including a computer server, servers, and other devices of any usable type and format and utilising any applicable format, and any applicable language, such as unix, linux, and windows, capable of providing storage, including hosting, space, room, environment and otherwise holding, said databases and said main computer code and said memory
whereby said server with said memory hosts said main computer code and said database, and said main computer code enables said communication to and from and between said users and said database and said operators of the system, to enable said users to trade, including buying and selling, said units in said assets from other said users and thereby raise funds, thus enabling substantial solutions to a multitude of problems including the on-going business and economic problem of the lack of business finance available to many small businesses, and also providing a vehicle for the general public to profit by directly investing in projects.

21. the machine of claim 20 further including a fourth means, including an additional computer code capable of enabling said communication to and from and between said users who are accessing said communication and said information via an interface device, including a graphic user interface and other digital devices, connected over a network, including the internet, the world wide web, and other networks.

22. the machine of claim 20 further including a fourth means, including an additional computer code capable of enabling and integrating said communication with external systems and third parties such that payments can be made from one said user to another said user.

23. the machine of claim 20 further including a fourth means, including an additional computer code capable of generating and adding to said information, a unique identifier and processing and adding to said information specific details about specific said units, including specific definitions as to how to divide specific said assets into their specific said units, and the relationship between specific said assets and their specific said units.

24. the machine of claim 20 further including a fourth means, including an additional computer code capable of accepting additional details, including documents and commentaries and opinions, from third parties, and adding these to the said information.

25. the machine of claim 20 further including a fourth means, including an additional computer code capable of communicating, including transmitting, sending and otherwise communicating, video and audio files such that they can be viewed by said users via a device connected to a network, including the internet and other networks.

26. the machine of claim 20 further including additional means, including computer codes, capable of enabling said communication to and from and between said users who are accessing said communication and said information via an interface device, including a GUI and other digital devices, connected over a network, including the internet, the world wide web, and other networks, and capable of enabling and integrating said communication with external systems and third parties such that payments can be made from one said user to another said user and capable of generating and adding to said information, a unique identifier and processing and adding to said information specific details about specific said units, including specific definitions as to how to divide specific said assets into their specific said units, and the relationship between specific said assets and their specific said units.
